(19) United States
(12) Patent Application Publication
(10) Pub. No.: US 2010/0212168 A1
(43) Pub. Date: Aug. 26, 2010

(54) DEVICE TO ASSIST IN FITTING A CUSTOM WHEEL TO AN AUTOMOBILE & METHODS OF USE THEREOF

(76) Inventor: Joseph T. Findeis, Lakewood, CA (US)

Correspondence Address: Loza & Loza LLP, 305 North Second Ave., #127, Upland, CA, 91786, US

(21) Appl. No.: 12/710,199

(22) Filed: Feb. 22, 2010

Related U.S. Application Data
(60) Provisional application No. 61/154,637, filed on Feb. 23, 2009.

(51) Int. Cl. G01B 1/00; G01D 21/00

(52) U.S. Cl. 33/203; 33/600

(57) ABSTRACT

Embodiments of the invention are directed to a device to assist in fitting a custom wheel to an automobile and methods of use thereof. In one embodiment, the device includes a plurality of measuring apparatuses for obtaining relevant measurements to assist in fitting a custom wheel to an automobile. In one method, a series of measurements pertaining to certain distances between a hub and a corresponding caliper of a vehicle wheel can be obtained using embodiments of the device of the invention. The measurements may be used to assist in the fitting of a custom wheel to an automobile.

### CLAIM OF PRIORITY

This application claims the benefit of U.S. Provisional Application No. 61/154,637 entitled “Device to Assist in Fitting a Custom Wheel to an Automobile & Methods of Use Thereof,” filed on Feb. 23, 2009.

### FIELD OF INVENTION

At least one feature pertains to a device to assist in fitting a custom wheel to an automobile and methods of use thereof.

### BACKGROUND OF INVENTION

The evolution of automobiles has resulted in vehicles being sold with larger brake assemblies compared to brake assemblies of older vehicles. For example, larger vehicles, such as sports utility vehicles (SUVs) and high performance passenger vehicles, come equipped with large brake assemblies from the original manufacturer. Additionally, after-market brake assembly manufacturers offer brake assembly upgrade conversions that, in some cases, may be larger in size relative to the brake assembly sold with the automobile by the original manufacturer. As a result, the installation of after-market custom parts (such as custom wheels) to many automobiles may be difficult, if not infeasible, due to these larger brake assemblies. For example, in the case of custom wheels, a larger brake assembly may present a problem of lack of clearance between the brake assembly and the vehicle's wheel. In these situations, the brake may make contact with the wheel and result in safety issues such as damage to the brake assembly and may also compromise the integrity of the wheel itself.

### SUMMARY OF INVENTION

A system for determining a fit between a wheel assembly and a vehicle, comprising: (i) measuring a distance between a front face of a hub and a side face of a caliper to obtain a first measurement; (ii) measuring a distance between a center point of the hub and a top face of the caliper to obtain a second measurement; (iii) measuring a distance between the center point of the hub to a bottom face of the caliper to obtain a third measurement; and (iv) comparing the first measurement, the second measurement and the third measurement to determine a fit between the wheel assembly and the vehicle is herein disclosed.

Measuring the distance between the front face of the hub and the side face of the caliper may comprise positioning at least one first gauge adjacent the hub and the side face of the caliper. Measuring the distance between the front face of the hub and the side face of the caliper may comprise repeatedly positioning a plurality of first gauges adjacent the hub and the side face of the caliper until a proximal end of the first gauge is flush against the hub and a distal end of the first gauge is flush against the side face of the caliper simultaneously. Each first gauge may have the same width at the proximal end and each first gauge may have a different width at the distal end. Measuring the distance between the center point of the hub to the top face of the caliper may comprise positioning a second gauge having a proximal end and a distal end adjacent the hub and the side face of the caliper, the proximal end positioned next to the center point of the hub. Measuring the distance between the center point of the hub to the bottom face of the caliper may comprise positioning a second gauge having a proximal end and a distal end adjacent the hub and the side face of the caliper, the proximal end positioned next to the center point of the hub.

The system may further comprise: measuring a distance between a wheel-mounting surface of a wheel assembly and an innermost surface of the wheel assembly to obtain a fourth measurement; and comparing the first measurement, the second measurement, the third measurement and the fourth measurement to determine a fit between the wheel assembly and the vehicle. Measuring the distance between the wheel-mounting surface of the wheel assembly and the innermost surface of the wheel assembly may comprise positioning a third gauge having a base and a perpendicularly-oriented screw therethrough at a distal end adjacent the wheel-mounting surface, the base adjacent the wheel-mounting surface and a shaft end of the screw positioned between the base and the innermost surface of the wheel assembly. The system may further comprise rotating the screw clockwise until the shaft end makes contact with the innermost surface of the wheel assembly. The system may further comprise, removing the third gauge from the wheel-mounting surface and positioning the third gauge adjacent to a fourth gauge having a proximal end and a distal end such that the base of the third gauge is flush against the distal end of the fourth gauge and the screw is parallel to an upper edge of the fourth gauge.

A device to determine a fit between a wheel assembly and a vehicle, comprising: (i) a plurality of first gauges, each first gauge having a proximal end and a distal end, each first gauge having the same width at the proximal end relative to one another, each first gauge having a different width at the distal end relative to one another; and (ii) a second gauge, the second gauge a straight-edge is herein disclosed. The proximal end of each first gauge may be a predetermined width and the distal end of each first gauge may be the predetermined width minus 0 or a factor of 4. Each first gauge may be adapted to measure a distance between a front face of a hub and a side face of a caliper to obtain a first measurement. The second gauge may be adapted to measure (i) a distance between a center point of the hub and a top face of the caliper to obtain a second measurement and (ii) a distance between the center point of the hub to a bottom face of the caliper to obtain a third measurement

The device may further comprise a third gauge, the third gauge having a proximal end and a distal end, the third gauge having a base and a perpendicularly-oriented screw therethrough at a distal end thereof, the screw adapted to rotate clockwise or counterclockwise, and a fourth gauge, the fourth gauge a straight-edge marked in increments of 4 millimeters. The third and fourth gauges may be adapted to measure a distance between a wheel-mounting surface of a wheel assembly and an innermost surface of the wheel assembly to obtain a fourth measurement.

A method of determining a fit between a wheel assembly and a vehicle, comprising: (i) positioning a plurality of first gauges adjacent a hub and a side face of a caliper until a proximal end of one of the plurality of first gauges is flush against the hub while a distal end of the first gauge is simultaneously flush against the side face of the caliper; and (ii) positioning a second gauge having a proximal end and a distal end adjacent the hub and the side face of the caliper, the proximal end positioned next to the center point of the hub is herein disclosed. The method may further comprise comparing a first measurement obtained from positioning the first gauge and a second and third measurement obtained from positioning the second gauge. The method may further comprise positioning a third gauge having a base and a perpendicularly-oriented screw therethrough at a distal end adjacent to a wheel-mounting surface, the base adjacent the wheel-mounting surface and a shaft end of the screw positioned between the base and an innermost surface of the wheel assembly. The method may further comprise comparing a first measurement obtained from positioning the first gauge, a second and third measurement obtained from positioning the second gauge, and a fourth measurement obtained from positioning the third gauge.

### BRIEF DESCRIPTION OF THE DRAWINGS

FIG. 1 illustrates an embodiment of a front view of a disc-brake assembly for a vehicle.

FIG. 2 illustrates a device according to an embodiment of the invention.

FIG. 3 illustrates representative embodiments of a first gauge with various X-Factors.

FIG. 4 illustrates a first step of a method of using a device according to one embodiment of the invention.

FIG. 5 illustrates a second step of a method of using a device according to one embodiment of the invention.

FIG. 6 illustrates an optional device which may be used in accordance to an embodiment of the invention.

FIGS. 7A-7B illustrate an optional third step of a method of using a device according to one embodiment of the invention.

### DETAILED DESCRIPTION

The following detailed description is of the best currently contemplated modes of carrying out the invention. The description is not to be taken in a limiting sense, but is made merely for the purpose of illustrating the general principles of the invention.

Embodiments of the invention are directed to a device to assist in fitting a custom wheel to an automobile and methods of use thereof. In one embodiment, the device includes a plurality of measuring apparatuses for obtaining relevant measurements to assist in fitting a custom wheel to an automobile. In one method, a series of measurements pertaining to certain distances between a hub and a corresponding caliper of a vehicle wheel can be obtained using embodiments of the device of the invention. The measurements may be used to assist in the fitting of a custom wheel to an automobile.

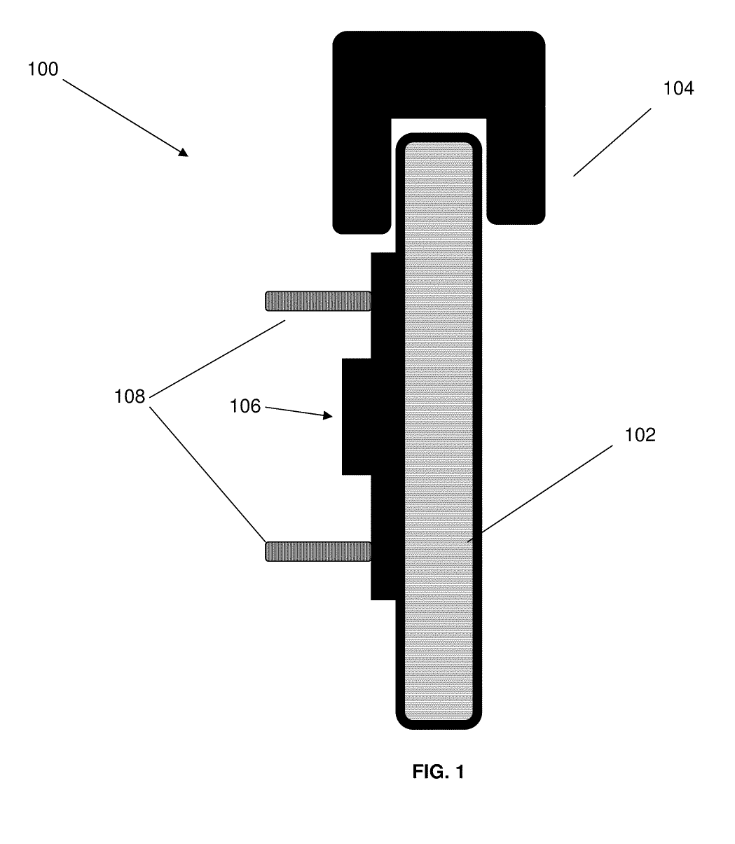

FIG. 1 illustrates an embodiment of a front view of a disc-brake assembly for a vehicle. As shown, the disc-brake assembly 100 includes a rotor or disc 102 and a caliper 104 straddling the rotor 102. During operation of a vehicle, the caliper 104 pushes a brake pad against the rotor 102 to initiate the slowing down or stopping of the vehicle. A hub 106 and a plurality of studs 108 protrude through openings (i.e., a center opening and a plurality of openings surrounding the center opening) of the rotor 102. The hub 106 functions to center a wheel when installed on a vehicle.

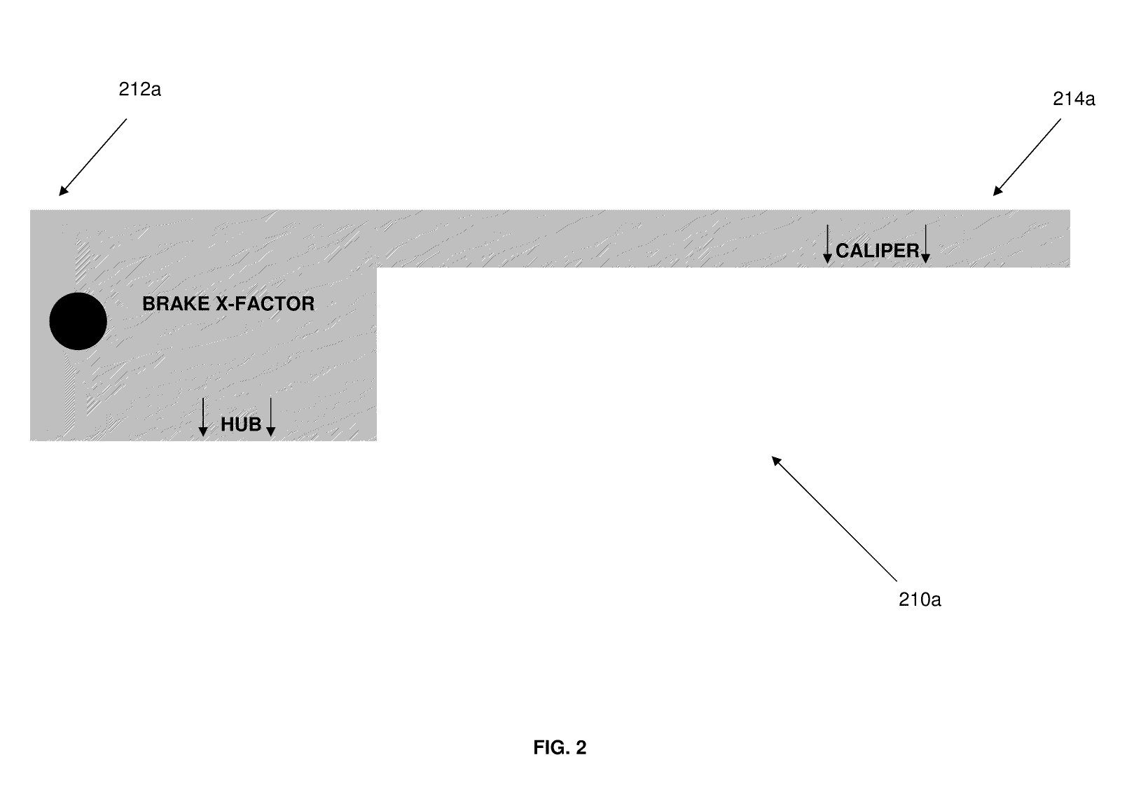

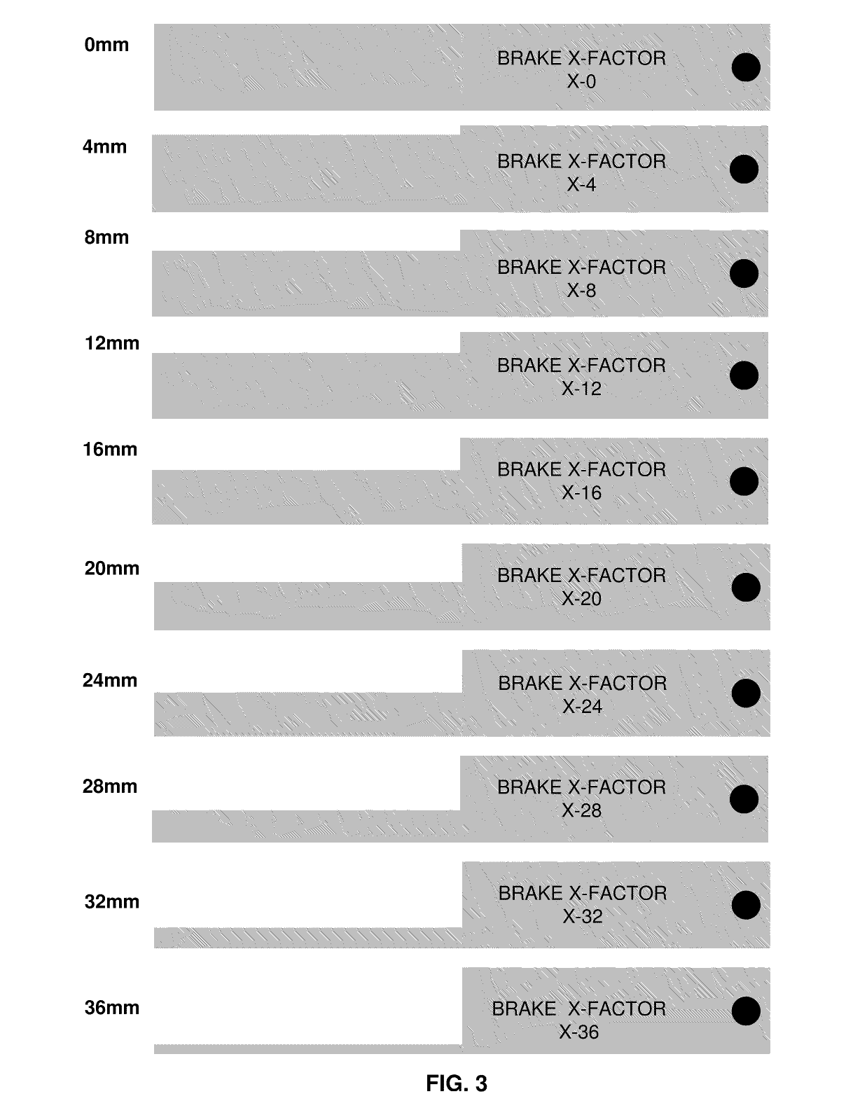

FIG. 2 illustrates a device according to an embodiment of the invention. According to this embodiment, the device is a first gauge 210a (or, “X-factor gauge”, hereinafter used interchangeably). The first gauge 210a may be a modified straight-edge having a portion with a predetermined width removed thereof. The first gauge 210a may have a proximal end 212a and a distal end 214a wherein the removed portion begins at the distal end 214a and terminates at a predetermined distance from the distal end 214a. The predetermined width of the removed portion may be between zero (0) millimeters (mm) and about forty-eight (48) mm, preferably, between zero (0) mm and thirty-six (36) mm. In one embodiment, first gauge 210a is approximately two (2) inches (in), i.e., 50.8 mm, in width at the proximal end 212a and between 50.8 mm and 14.8 mm in width at the distal end 214a. The corresponding predetermined width of the removed portion is therefore between zero (0) mm and thirty-six (36) mm. In some embodiments, the predetermined width of the removed portion of first gauge 210a may be provided in four (4) mm increments, i.e., zero (0) mm, four (4) mm, eight (8) mm, twelve (12), sixteen (16), twenty (20), twenty-four (24), twenty-eight (28), thirty-two (32), thirty-six (36), etc. This predetermined width may correspond to a brake “X-Factor” (explained in more detail below). In use, the distal portion 214a is positioned against a caliper of a vehicle while the proximal portion 212a is simultaneously positioned against a hub of the vehicle. FIG. 3 illustrates representative embodiments of first gauge 210a with various X-Factors, i.e., predetermined widths of the removed portion in four (4) mm increments. In one embodiment, each X-Factor gauge may have an opening therein such that a plurality of X-Factor gauges can be grouped together on a ring.

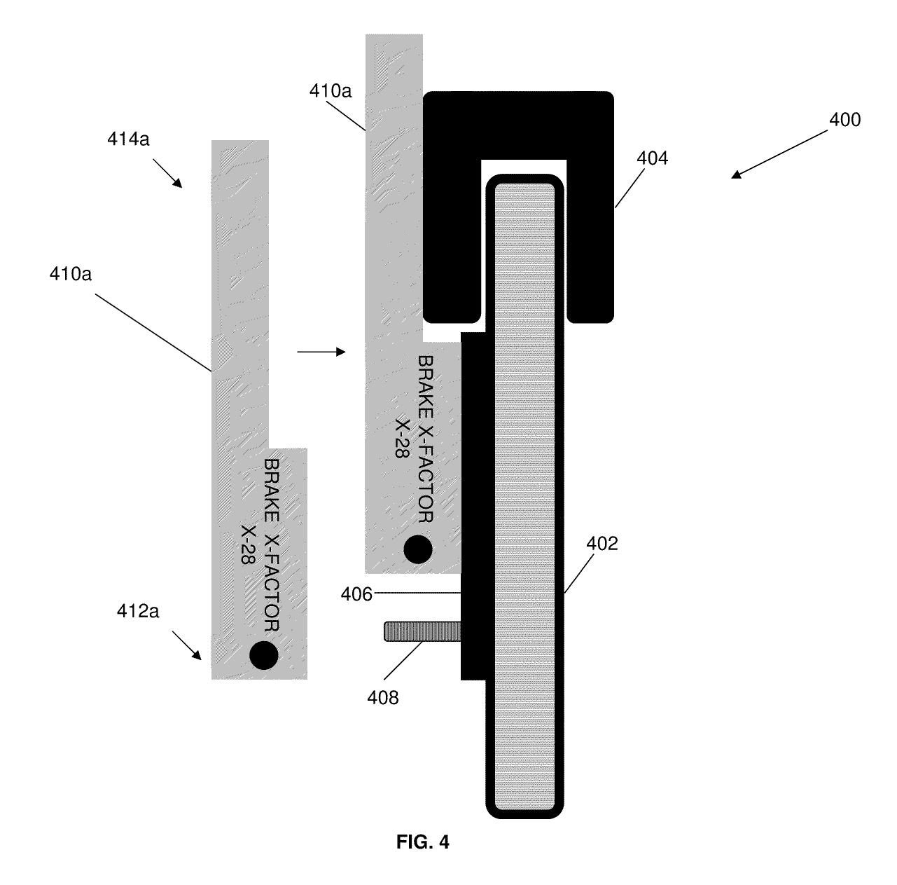

FIG. 4 illustrates a first step of a method of using a device according to one embodiment of the invention. Similar to FIG. 1 and as shown, a disc-brake assembly 400 includes a rotor or disc 402 and a caliper 404 straddling the rotor 402. A hub 406 and a plurality of studs 408 protrude through openings (i.e., a center opening and a plurality of openings surrounding the center opening) of rotor 402. According to one embodiment, a first gauge 410a having a removed portion with a predetermined width is positioned adjacent to the hub 406 and the caliper 404 (with the wheel and tire assembly removed from the vehicle). The first gauge 410a is positioned such that a proximal end 412a, i.e., wider end (or base), is in contact with a side face of the rotor 402 while the distal end 414a, i.e., narrower end, is in contact with a side face of the caliper 404. The first gauge 410a may be one of a plurality of first gauges having a predetermined width with the removed portion in a four (4) mm increment (see FIG. 3). If the proximal end 412a is flush against the side face of the rotor 402 while the distal end 414a is simultaneously flush against the side face of the caliper 404, then the appropriate first gauge 410a has been selected by the user. If, on the other hand, the proximal end 412a is flush against the side face of the rotor 402 while the distal end 414a simultaneously is not flush against the side face of the caliper 404, or vice-versa, then the user must test another first gauge 410a with a different X-Factor until the appropriate first gauge 410a is selected. Thus, the user may test between one to “n” X-Factor gauges from a plurality of X-Factor gauges until the appropriate X-Factor gauge is selected. In this manner, a distance between the face of the rotor 402 and the face of the caliper 404 can be obtained by merely selecting (by trial and error) the appropriate first gauge 410a. This distance is termed the brake “X-Factor.”

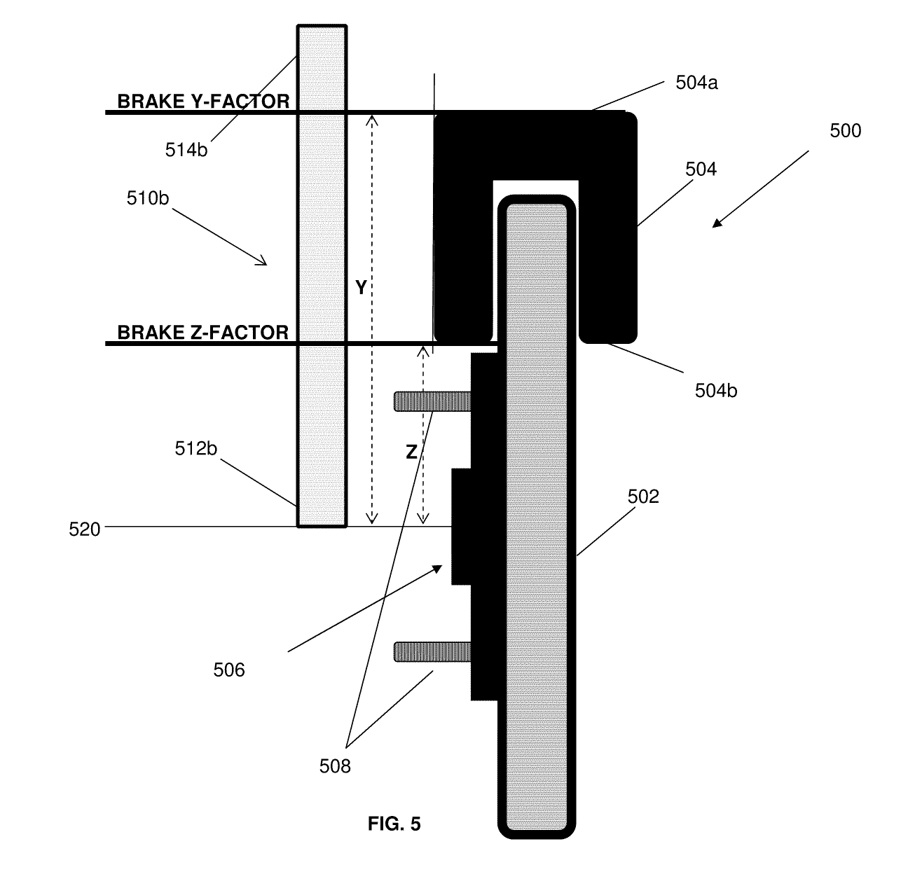

FIG. 5 illustrates a second step of a method of using a device according to one embodiment of the invention. Similar to FIG. 1 and as shown, the disc-brake assembly 500 includes a rotor or disc 502 and a caliper 504 straddling the rotor 502. A hub 506 and a plurality of studs 508 protrude through openings (i.e., a center opening and a plurality of openings surrounding the center opening) of the rotor 502. According to one embodiment, a second gauge 510b having a proximal end 512b and a distal end 514b may be used to obtain distances termed the brake “Y-Factor” and the brake “Z-Factor.” In one embodiment, the second gauge 510b is a standard ruler with metric units marked thereon. The second gauge 510b may be used to measure distances from a hub center line 520 to a top face 504a of the caliper 504 and a bottom face 504b of the caliper 504. In this manner, a distance between the hub center line 520 and the bottom face 504b of the caliper 504 can be obtained, termed the brake “Z-Factor,” and a distance between the hub center line 520 and the top face 504a of the caliper 504 can simultaneously be obtained, termed the brake “Y-Factor.” The various brake “Factors” may be summarized as follows:
Brake X-Factor: The distance from a vehicle's hub face to an outer edge of the caliper (also known as the caliper overhang)
Brake Y-Factor: The distance from the center of a vehicle's hub to the top of the caliper
Brake Z-Factor: The distance from the center of a vehicle's hub to the bottom of the caliper

In this manner, obtaining measurements representing the brake X-Factor, the brake Y-Factor, and the brake Z-Factor, allows a determination in advance as to whether a particular wheel assembly will fit to a particular vehicle based on the brake assembly attached thereto. This method or system can be used upstream, e.g., at the manufacturer end, or downstream, e.g., at the consumer end, to determine whether a particular wheel assembly is or will be compatible with a particular vehicle depending on the brake assembly. It should be appreciated that the steps can be performed in any order and still fall within the scope of the invention.

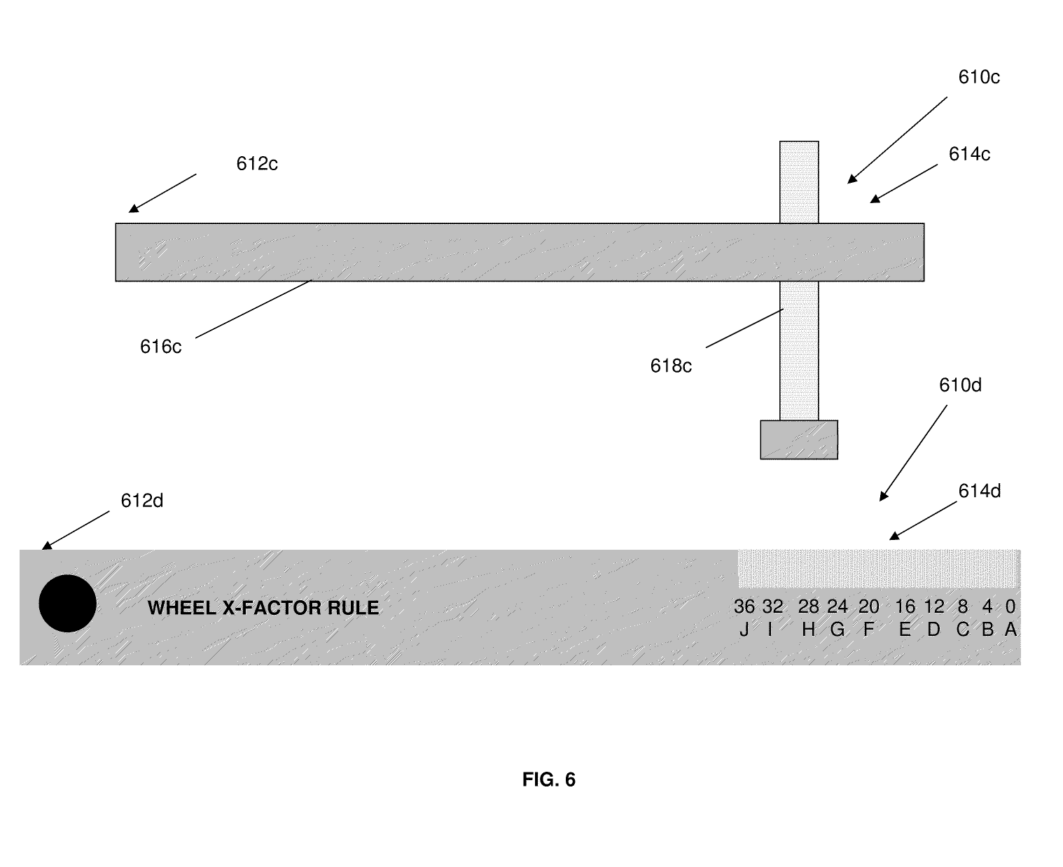

FIG. 6 illustrates an optional device which may be used in accordance to an embodiment of the invention. According to this embodiment, the device includes a third gauge 610c and a fourth gauge 610d. The third gauge 610c may be comprised of a base 616c and a screw 618c. Third gauge 610c may have a proximal end 612c and a distal end 614c. In one embodiment, screw 618c may threadedly engage with a threaded opening (not shown) near the distal end 614c of third gauge 610c. Screw 618c may be a flathead screw or any other suitable screw known by one of those known by one of ordinary skill in the art. In one embodiment, screw 618c is at an approximately ninety (90) degree angle relative to base 616c. In one embodiment, base 616c may be approximately seven (7) inches in length and approximately 0.5 inches in width and approximately 0.5 inches in depth.

Continuing to refer to FIG. 6, the fourth gauge 610d may be a straight-edge having a proximal end 612d and a distal end 614d. A length of fourth gauge 610d may be approximately nine (9) inches. In some embodiments, the distal end 614d of fourth gauge 610d has metric units marked thereon, e.g., metric units marked in four (4) mm increments from zero (0) mm to thirty-six (36) mm and labeled A through J.

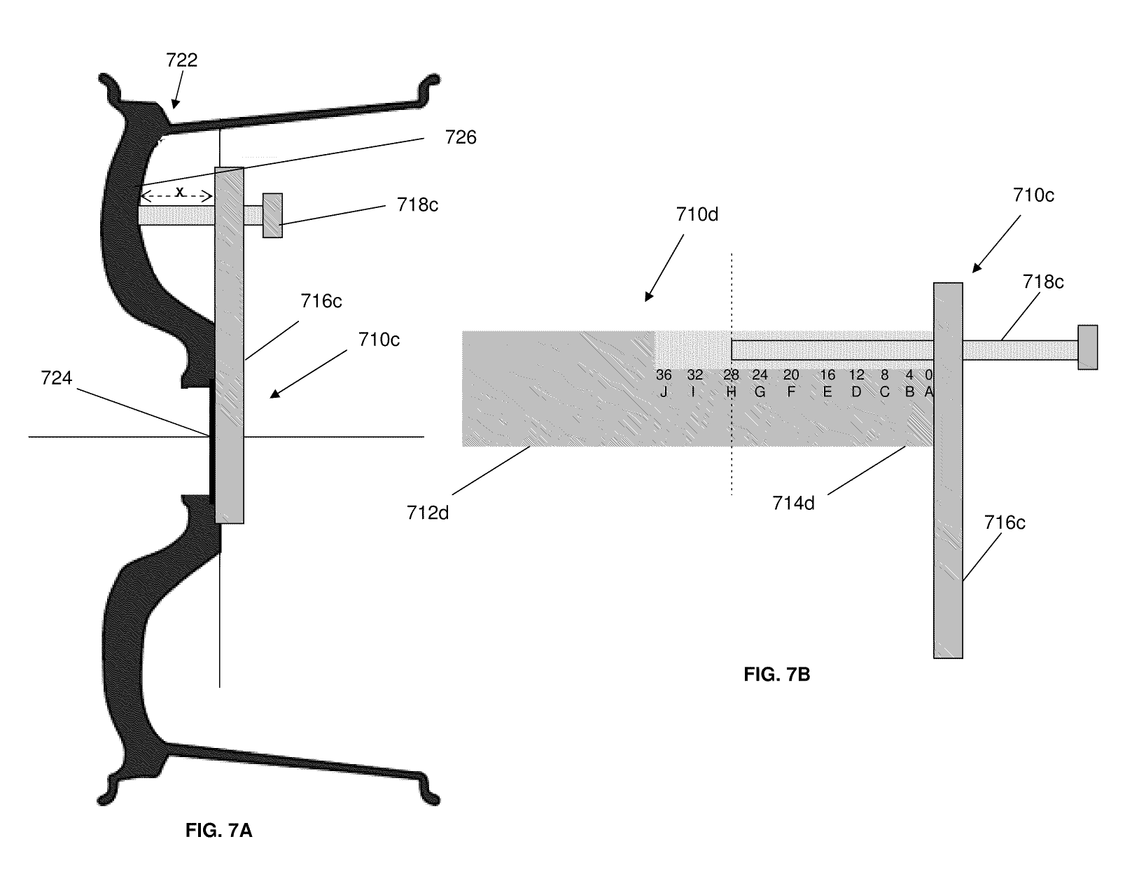

FIGS. 7A-7B illustrate an optional third step of a method of using a device according to one embodiment of the invention. FIG. 7A illustrates a side view of a wheel 722. A third gauge 710c having a base 716c and a perpendicularly-oriented screw 718c (relative to the base 716c) is positioned adjacent a wheel-mounting surface 724 with a head of the screw 718c (proximal end) outer-facing relative to the wheel-mounting surface 724 and a shaft of the screw 718c (distal end) facing an inner surface 726 of the wheel 722, i.e., the backside of the wheel 722. According to one embodiment, the screw 718c is turned clockwise by a user until its distal end makes contact with an innermost portion of the inner surface 726 of the wheel 722. Once the screw 718c makes contact with this innermost portion, the third gauge 710c is removed by the user and positioned adjacent to a fourth gauge 710d (see FIG. 7B). In one embodiment, the base 716c of fourth gauge 710c is put into contact with a distal end 714d of fourth gauge 710d such that screw 718c of third gauge 710c is parallel to the distal end 714d of the fourth gauge 710d. The distance between the base 716c and the distal end of the screw 718c (as measured by the metric units on the distal end 714d of the fourth gauge 710d gives the wheel “X-Factor”, or depth, of a particular wheel assembly if not already known. In this manner, taking into consideration the brake X-Factor, the brake Y-Factor, the brake Z-Factor and the wheel X-Factor (if not already known), it can be determined in advance whether a particular wheel assembly will fit to a particular vehicle based on the brake assembly attached thereto. This method or system can be used upstream, e.g., at the manufacturer end, or downstream, e.g., at the consumer end, to determine whether a particular wheel assembly is or will be compatible with a particular vehicle depending on the brake assembly. It should be appreciated that the steps can be performed in any order and still fall within the scope of the invention.

While certain exemplary embodiments have been described and shown in the accompanying drawings, it is to be understood that such embodiments are merely illustrative of and not restrictive on the broad invention, and that this invention is not limited to the specific constructions and arrangements shown and described, since various other modifications may occur to those ordinarily skilled in the art.

What is claimed is:

1. A system for determining a fit between a wheel assembly and a vehicle, comprising:
measuring a distance between a front face of a hub and a side face of a caliper to obtain a first measurement;
measuring a distance between a center point of the hub and a top face of the caliper to obtain a second measurement;
measuring a distance between the center point of the hub to a bottom face of the caliper to obtain a third measurement; and
comparing the first measurement, the second measurement and the third measurement to determine a fit between the wheel assembly and the vehicle.

2. The system of claim 1 wherein measuring the distance between the front face of the hub and the side face of the caliper comprises positioning at least one first gauge adjacent the hub and the side face of the caliper.

3. The system of claim 1 wherein measuring the distance between the front face of the hub and the side face of the caliper comprises repeatedly positioning a plurality of first gauges adjacent the hub and the side face of the caliper until a proximal end of the first gauge is flush against the hub and a distal end of the first gauge is flush against the side face of the caliper simultaneously.

4. The system of claim 3 wherein each first gauge has the same width at the proximal end and each first gauge has a different width at the distal end.

5. The system of claim 1 wherein measuring the distance between the center point of the hub to the top face of the caliper comprises positioning a second gauge having a proximal end and a distal end adjacent the hub and the side face of the caliper, the proximal end positioned next to the center point of the hub.

6. The system of claim 1 wherein measuring the distance between the center point of the hub to the bottom face of the caliper comprises positioning a second gauge having a proximal end and a distal end adjacent the hub and the side face of the caliper, the proximal end positioned next to the center point of the hub.

7. The system of claim 1, further comprising,
measuring a distance between a wheel-mounting surface of a wheel assembly and an innermost surface of the wheel assembly to obtain a fourth measurement; and
comparing the first measurement, the second measurement, the third measurement and the fourth measurement to determine a fit between the wheel assembly and the vehicle.

8. The system of claim 7 wherein measuring the distance between the wheel-mounting surface of the wheel assembly and the innermost surface of the wheel assembly comprises positioning a third gauge having a base and a perpendicularly-oriented screw therethrough at a distal end adjacent the wheel-mounting surface, the base adjacent the wheel-mounting surface and a shaft end of the screw positioned between the base and the innermost surface of the wheel assembly.

9. The system of claim 8, further comprising, rotating the screw clockwise until the shaft end makes contact with the innermost surface of the wheel assembly.

10. The system of claim 9, further comprising,
removing the third gauge from the wheel-mounting surface; and
positioning the third gauge adjacent to a fourth gauge having a proximal end and a distal end such that the base of the third gauge is flush against the distal end of the fourth gauge and the screw is parallel to an upper edge of the fourth gauge.

11. A device to determine a fit between a wheel assembly and a vehicle, comprising:
a plurality of first gauges, each first gauge having a proximal end and a distal end, each first gauge having the same width at the proximal end relative to one another, each first gauge having a different width at the distal end relative to one another; and
a second gauge, the second gauge a straight-edge.

12. The device of claim 11 wherein (i) the proximal end of each first gauge is a predetermined width and (ii) the distal end of each first gauge is the predetermined width minus 0 or a factor of 4.

13. The device of claim 12 wherein each first gauge is adapted to measure a distance between a front face of a hub and a side face of a caliper to obtain a first measurement.

14. The device of claim 11 wherein the second gauge is adapted to measure (i) a distance between a center point of the hub and a top face of the caliper to obtain a second measurement and (ii) a distance between the center point of the hub to a bottom face of the caliper to obtain a third measurement.

15. The device of claim 12, further comprising:
a third gauge, the third gauge having a proximal end and a distal end, the third gauge having a base and a perpendicularly-oriented screw therethrough at a distal end thereof, the screw adapted to rotate clockwise or counterclockwise; and
a fourth gauge, the fourth gauge a straight-edge marked in increments of 4 millimeters.

16. The device of claim 15 wherein the third and fourth gauges are adapted to measure a distance between a wheel-mounting surface of a wheel assembly and an innermost surface of the wheel assembly to obtain a fourth measurement.

17. A method of determining a fit between a wheel assembly and a vehicle, comprising:
positioning a plurality of first gauges adjacent a hub and a side face of a caliper until a proximal end of one of the plurality of first gauges is flush against the hub while a distal end of the first gauge is simultaneously flush against the side face of the caliper; and
positioning a second gauge having a proximal end and a distal end adjacent the hub and the side face of the caliper, the proximal end positioned next to the center point of the hub.

18. The method of claim 17, further comprising, comparing a first measurement obtained from positioning the first gauge and a second and third measurement obtained from positioning the second gauge.

19. The method of claim 17, further comprising, positioning a third gauge having a base and a perpendicularly-oriented screw therethrough at a distal end adjacent to a wheel-mounting surface, the base adjacent the wheel-mounting surface and a shaft end of the screw positioned between the base and an innermost surface of the wheel assembly.

20. The method of claim 19, further comprising, comparing a first measurement obtained from positioning the first gauge, a second and third measurement obtained from positioning the second gauge, and a fourth measurement obtained from positioning the third gauge.
